(19) United States
(12) Patent Application Publication
(10) Pub. No.: US 2008/0197191 A1
(43) Pub. Date: Aug. 21, 2008

(54) IMAGE PROCESSING APPARATUS AND METHOD FOR OPERATING IMAGE PROCESSING APPARATUS

(75) Inventors: Hiroshi Watanabe, Kanagawa-ken (JP); Takao Iwasaki, Tokyo (JP); Beniko Matsumoto, Shizuoka-ken (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/676,326

(22) Filed: Feb. 19, 2007

(51) Int. Cl. G06K 5/00

(52) U.S. Cl. 235/382

(57) ABSTRACT

It is an object of the invention to provide an image processing apparatus and a method for operating the image processing apparatus that can effectively use electric power by preventing units not used by specified users from being brought into an operation state.

An image processing apparatus according to the invention is an image processing apparatus that can selectively switch any one of plural units having respective functions from a power saving mode to a normal operation mode and switches, when the unit in the normal operation mode is not used for a time set in advance, to the power saving mode. The image processing apparatus includes a card identifier storing unit having stored therein a card identifier indicating that a card is a card of a proper user and a usable unit given to the card identifier and a card reading control unit that reads a card identifier of a card set in a reading state, searches through the card identifier storing unit, and, only when the card is the card of the proper user, brings a unit corresponding to the card identifier into a normal operation state.

### BACKGROUND OF THE INVENTION

1. Field of the Invention

The present invention relates to an image processing apparatus and a method for operating the image processing apparatus, and, more particularly to an image processing apparatus and a method for operating the image processing apparatus that can provide various functions and are effective for power saving.

2. Description of the Related Art

There is known an image processing apparatus that has plural stages of power saving modes, detects a distance between a user carrying a portable terminal and the image processing apparatus, and switches a power saving mode to a normal operation mode, which is a normal operable state, stepwise according to a state in which the user approaches the image processing apparatus. According to this image processing apparatus, for example, when a print job is present in a printing apparatus, it is possible to reduce a waiting time of a user who has reached the image processing apparatus (e.g., JP-A-2002-86846).

However, in the conventional image processing apparatus described above, although identification of a user is tentatively performed, there is no restriction on what kind of functions the user can use. When the power saving mode is reset to the normal operation mode, the entire apparatus is reset. Therefore, there is a problem in that electric power is uselessly supplied even to units that the user does not use.

### SUMMARY OF THE INVENTION

The present invention has been devised in order to solve the problems described above and it is an object of the invention to provide an image processing apparatus and a method for operating the image processing apparatus that can identify a user and can effectively use electric power by setting units usable by users for each of the users in advance and preventing units not used by the users from being brought into an operation state.

In order to solve the problems described above, an image processing apparatus according to the invention includes a user identifying unit that identifies a user, a unit specifying unit that specifies any one or more of plural units having functions different from one another stored in advance in association with the user identified by the user identifying unit, and a mode switching unit that switches the unit specified by the unit specifying unit from a power saving mode, which is a power saving state, to a normal operation mode, which is a normal operable state.

An image processing apparatus according to the invention includes user identifying means for identifying a user, unit specifying means for specifying any one or more of plural units having functions different from one another stored in advance in association with the user identified by the user identifying means, and mode switching means for switching the unit specified by the unit specifying means from a power saving mode, which is a power saving state, to a normal operation mode, which is a normal operable state.

A method for operating an image processing apparatus according to the invention includes a user identifying step of identifying a user, a unit specifying step of specifying any one or more of plural units having functions different from one another stored in advance in association with the user identified in the user identifying step, and a mode switching step of switching the unit specified in the unit specifying step from a power saving mode, which is a power saving state, to a normal operation mode, which is a normal operable state.

### DESCRIPTION OF THE DRAWINGS

FIG. 1 is a block diagram showing an example of an embodiment of an image processing apparatus of the invention; and

FIG. 2 is a flowchart showing an operation based on reading a radio card of the image processing apparatus in FIG. 1.

### DESCRIPTION OF THE EMBODIMENTS

An embodiment of the invention will be hereinafter explained with reference to the drawings.

### First Embodiment

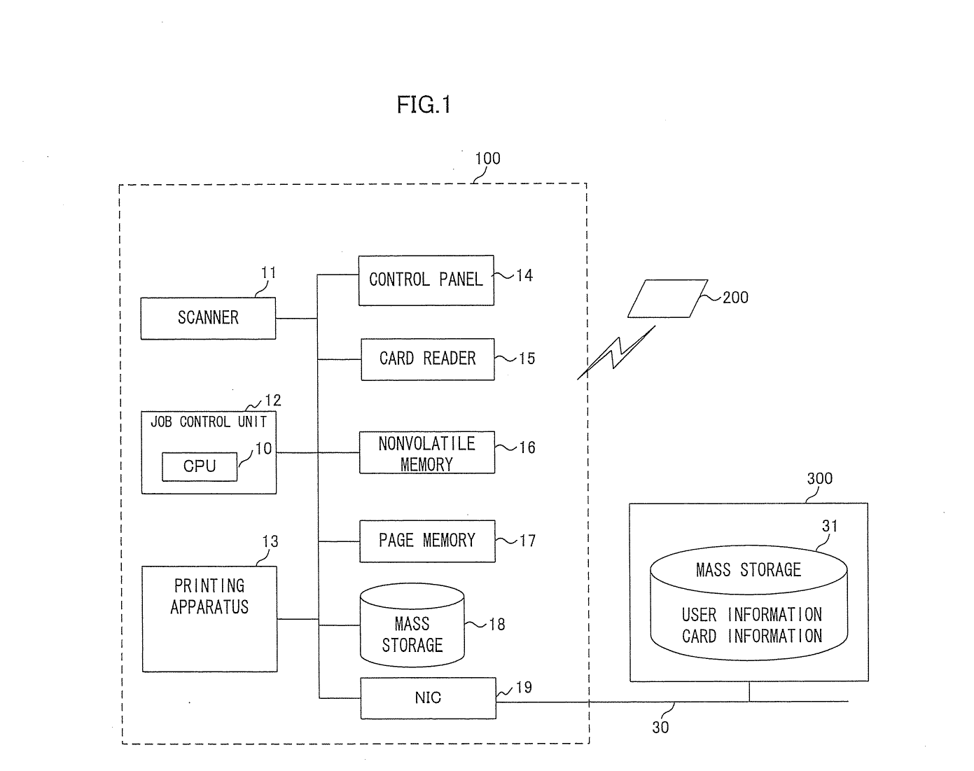

An image processing apparatus (MFP) 100 in FIG. 1 has a scanner 11, a job control unit 12 including a CPU 10, a printing apparatus 13, a control panel 14, a card reader 15, a nonvolatile memory 16, a page memory 17, a mass storage 18, and a NIC (Network Interface Card) 19.

The image processing apparatus 100 reads, in the job control unit thereof, a card identifier of a radio card 200 brought close to the card reader 15 and identifies whether a user of the radio card 200 is registered as a proper user.

The image processing apparatus 100 is connected to a user management server 300 via the NIC 19 and a network 30. In this case, the user management server 300 has a mass storage 31 for storing user information and card information.

A storing unit (storing means) corresponding to this mass storage 31 may be provided in the image processing apparatus 100.

In the image processing apparatus 100 described above, the job control unit 12 collectively controls the respective units 11 to 19 using the CPU 10 and executes and manages jobs.

The scanner 11 optically scans an original and generates image data. The printing apparatus 13 prints image data on a print sheet. The control panel 14 is a device through which a user applies operation to the image processing apparatus 100. A start key for instructing start of scanning of an original, alphabet keys, a ten key for inputting numbers, a display panel (e.g., a liquid crystal panel), and the like, which are not shown in the figure, are prepared on the control panel 14.

The card reader 15 reads, in a non-contact manner, recorded contents of a card held over the card reader 15. The nonvolatile memory 16 is, for example, a flash ROM and stores programs, parameters, and the like necessary for control. The page memory 17 temporarily stores image data such as print data. The mass storage 18 is a storage medium that can perform mass storage such as a hard disk. The NIC 19 performs exchange of data with external apparatuses via the network 30.

The card reader 15 is equivalent to a user identifying unit and user identifying means of the invention. The job control unit 12 constitutes a mode switching unit and mode switching means, a unit specifying unit and unit specifying means, and a display control unit and display control means of the invention.

In units in the image processing apparatus 100, for example, the scanner 11, the printing apparatus 13, and the control panel 14, it is possible to set a normal operation mode, which is a normal operable state, or a power saving mode, which is a power saving state, respectively. An example of management of the setting will be explained with reference to Table 1.

TABLE 1

| | | | Remaining Time |
|---|---|---|---|
| Unit Name | State | Waiting Time | Counter |
| Control panel | Normal | 300 sec | 240 sec |
| Scanner | Normal | 60 sec | 50 sec |
| Printing | Power saving | 180 sec | 0 sec |
| apparatus | | | |

In this case, the table indicates that an operation state (an operation mode) of the control panel 14 controlled by the CPU 10 is the normal operation mode, when there was the last operation on the control panel 14, a waiting time of 300 seconds was set in a remaining time counter, after that, 60 seconds have passed without any operation on the control panel 14 (operation including an instruction from the card reader), and a remaining time for continuing the normal operation has decreased to 240 seconds.

Therefore, if no operation of the control panel 14 further continues exceeding 240 seconds, the control panel 14 is switched to be set in the power saving mode. Conversely, if there is operation of the control panel 14 within 240 seconds, the remaining time counter is set to 300 seconds again.

Similarly, an operation state (an operation mode) of the scanner 11 is the normal operation mode. When there was the last operation on the scanner 11, a waiting time of 60 seconds was set in the remaining time counter. After that, 10 seconds has passed without any operation of the scanner 11 and the remaining time counter has been reduced to 50 seconds.

An operation state (an operation mode) of the printing apparatus 13 is the power saving mode. When there was the last operation on the printing apparatus 13, a waiting time of 180 seconds was set in the remaining time counter. After that, 180 seconds have passed without any operation of the printing apparatus 13 and a value of the remaining time counter has decreased to 0 second. Thus, the operation mode is set to the power saving mode.

As the shift from the normal operation mode to the power saving mode of a unit, other than a method in which the unit automatically performs the shift, a method may be adopted in which a CPU reduces the remaining time counter at a fixed time interval in response to timer interrupt and, when the remaining time counter decreases to zero second or less, changes a mode to the power saving mode.

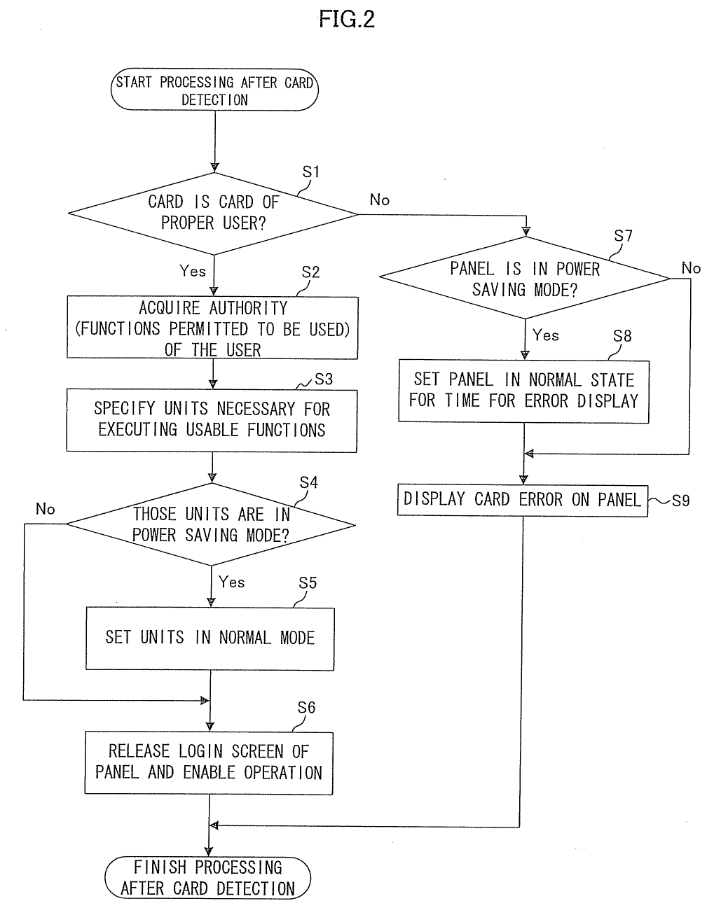

An operation of the image processing apparatus 100, which has detected presentation of a radio card, will be explained with reference to FIG. 2.

When the radio card 200 is brought close to the card reader 15 of the image processing apparatus 100, the card reader 15 reads card identification information of the radio card 200. The CPU 10 identifies (determines) whether a card identifier in the card identification information read by the card reader 15 is registered as a proper user (S1: user identifying means, a user identifying step).

As a method of identification, there are, for example, a method of creating a database (DB) in the mass storage (an HDD, etc.) 18 in advance and finding whether a read card identifier is registered in the DB, or a method of inquiring, using a network, whether a card identifier read is registered in an external server that manages card identification information of a user. In the following explanation, unless specifically noted otherwise, identification is performed by the latter method.

When the network is used, it is preferable that communication data transmitted through the network is encrypted by the TLS (Transport Layer Security) or the like.

According to the inspection described above, when it is determined that the card identifier is registered as a proper user, the CPU 10 acquires authority concerning the use of a function set for the user (S2).

In this case, concerning various functions held by the image processing apparatus 100, when usable functions are restricted for each user, the CPU 10 registers, with a user management server connected by the network 30 (e.g., LDAP (Lightweight Directory Access Protocol) server 300 (the mass storage 31: a storing unit), information associating each user with functions (units) usable by each user or functions prohibited to be used, when a user is identified from a card identifier, acquires, from the user management server 300, information concerning units for executing functions (in this embodiment for example, a scanner and a printing apparatus) usable by the identified user, and specifies the units (S3: unit specifying means, a unit specifying step).

The CPU 10 determines whether a state (see, for example, Table 1) of the units specified in step S3 is the power saving mode (S4). When the units are in the power saving state in the determination in step S4, the CPU 10 changes the power saving state to the normal state and sets a waiting time in the remaining time counter (S5: mode switching means, a mode switching step). Thereafter, the CPU 10 releases a login screen of the control panel, enables operation (S6), and finishes the operation. When the units are not in the power saving mode but are in the normal mode in step S4, the CPU 10 immediately shifts the process to step S6.

When it is not determined in step S1 that the radio card 200 is not a radio card of a proper user, the CPU 10 determines whether a state of the control panel 14 is the power saving mode (S7). When the control panel 14 is in the power saving mode, the CPU 10 changes only the control panel 14 to the normal state to enable display and sets a time for error display in the remaining time counter (see Table 1) (S8: display control means, a display control step).

After step S8, the CPU 10 causes the control panel 14 to perform error display indicating that “the card is not correct” and, when the time for error display has passed, causes the control panel 14 to finish the error display and shift to the power saving state (S9).

In the above explanation, the example in which the radio card is used is explained as the embodiment of the invention. However, it is evident that it is possible to apply the invention to contact type cards such as a magnetic card as long as the cards are other portable small media.

It is also possible to apply the user identifying means, the unit specifying means, the mode switching means, and the display control means explained in this embodiment to a program that causes a computer to execute the method for operating an image processing apparatus explained according to the flowchart described in the embodiment. This program is recorded in a computer-readable recording medium and has a function of being read by the computer and causing the computer to execute the method for operating an image processing apparatus of the invention.

Concerning such functions, in the explanation of this embodiment, functions for carrying out the invention are recorded in the apparatus in advance. However, the invention is not limited to this. The same functions may be downloaded to the apparatus from the network or the same functions stored in a recording medium may be installed in the apparatus. A form of the recording medium may be any form as long as the recording medium is a recording medium that can store a program and is readable by the apparatus such as a CD-ROM. The functions obtained by installation or download in advance in this way may be realized in cooperation with an OS (operating system) or the like in the apparatus.

What is claimed is:

1. An image processing apparatus comprising:
a user identifying unit configured to identify a user;
a unit specifying unit configured to specify any one or more of plural units having functions different from one another stored in advance in association with the user identified by the user identifying unit; and
a mode switching unit configured to switch the unit specified by the unit specifying unit from a power saving mode, which is a power saving state, to a normal operation mode, which is a normal operable state.

2. An image processing apparatus according to claim 1, wherein the user identifying unit is constituted by a card reader that reads a user card.

3. An image processing apparatus according to claim 2, wherein the user card is a radio card or a magnetic card.

4. An image processing apparatus according to claim 1, comprising a storing unit configured to store, in association with the user, one or more of the plural units having functions different from one another.

5. An image processing apparatus according to claim 1, wherein the mode switching unit switches, when a unit in the normal operation mode is not used for a time set in advance, the unit to the power saving mode.

6. An image processing apparatus according to claim 5, wherein the time set in advance is set for each of the plural units.

7. An image processing apparatus according to claim 1, comprising a display control unit that sets, when the user identified by the user identifying unit is determined as not being a proper user, a display panel of the image processing apparatus in the normal operation mode and performs display indicating that a card is not correct.

8. An image processing apparatus according to claim 7, wherein the display on the display panel by the display control unit is performed for a display time set in advance.

9. An image processing apparatus comprising:
user identifying means for identifying a user;
unit specifying means for specifying any one or more of plural units having functions different from one another stored in advance in association with the user identified by the user identifying means; and
mode switching means for switching the unit specified by the unit specifying means from a power saving mode, which is a power saving state, to a normal operation mode, which is a normal operable state.

10. An image processing apparatus according to claim 9, wherein the user identifying means is constituted by a card reader that reads a user card.

11. An image processing apparatus according to claim 10, wherein the user card is a radio card or a magnetic card.

12. An image processing apparatus according to claim 9, comprising storing means for storing, in association with the user, one or more of the plural units having functions different from one another.

13. An image processing apparatus according to claim 9, wherein the mode switching means switches, when a unit in the normal operation mode is not used for a time set in advance, the unit to the power saving mode.

14. An image processing apparatus according to claim 9, wherein the time set in advance is set for each of the plural units.

15. An image processing apparatus according to claim 9, comprising display control means for setting, when the user identified by the user identifying means is determined as not being a proper user, displaying means of the image processing apparatus in the normal operation mode and performing display indicating that a card is not correct.

16. An image processing apparatus according to claim 15, wherein the display on the displaying means by the display control means is performed for a display time set in advance.

17. A method for operating an image processing apparatus comprising the steps of:
identifying a user;
specifying any one or more of plural units having functions different from one another stored in advance in association with the user identified in the step of identifying a user; and
switching the unit specified in the step of specifying a unit from a power saving mode, which is a power saving state, to a normal operation mode, which is a normal operable state.

18. A method for operating an image processing apparatus according to claim 17, wherein the step of identifying a user is performed by reading a user card.

19. A method for operating an image processing apparatus according to claim 17, wherein the user card is a radio card or a magnetic card.

20. A method for operating an image processing apparatus according to claim 17, comprising a display control unit that sets, when the user identified by the user identifying unit is determined as not being a proper user, a display panel of the image processing apparatus in the normal operation mode and performs display indicating that a card is not correct.
